(19) United States
(12) Patent Application Publication
(10) Pub. No.: US 2005/0041587 A1
(43) Pub. Date: Feb. 24, 2005

(54) Providing information on ethernet network congestion

(76) Inventor: Sung-Won Lee, Seongnam-si (KR)

Correspondence Address: Robert E. Bushnell, Suite 300, 1522 K Street, N.W., Washington, DC, 20005-1202, US

(21) Appl. No.: 10/920,224

(22) Filed: Aug. 18, 2004

(30) Foreign Application Priority Data
Aug. 20, 2003 (KR) 2003-57731

(51) Int. Cl. H04L 12/26

(52) U.S. Cl. 370/236; 370/359

(57) ABSTRACT

Providing information on congestion of an Ethernet network make it possible for a host and a server located at an end of a communication network to determine whether or not a congested section of the communication network has occurred to thereby actively adjust the amount of packets to be transmitted. This make it possible to not only reduce the duration of the congestion resulting from a delay and a processing delay in the communication network, but also to prevent burst traffic from being generated within the communication network, and to provide stabilization of the communication network in the end.

### CLAIM OF PRIORITY

This application makes reference to, incorporates the same herein, and claims all benefits accruing under 35 U.S.C. §119 from an application for DEVICE AND METHOD FOR NOTIFYING INFORATION ON CONGESTION OF ETHERNET NETWORK earlier filed in the Korean Intellectual Property Office on 20 Aug. 2003 and there duly assigned Serial No. 2003-57731.

### BACKGROUND OF THE INVENTION

1. Field of the Invention

The present invention relates to an Ethernet switch. More particularly, the present invention is directed to providing information on Ethernet network congestion, by detecting a congested section of an Ethernet switch device transmitting an Ethernet packet or Ethernet transmission link and providing information to a host or server located at an end of the Ethernet network as to whether or not congestion has occurred.

2. Description of the Related Art

As the Internet is popularized, the amount of information exchanged has significantly increased with the explosive growth of Internet traffic. Thus, it is necessary to transmit packets in a more rapid and efficient manner.

Hence, communication equipment, such as a router, detect a congested section of router equipment or a router transmission link in order to actively process more rapid and efficient transmission of the packets, and provide information to a terminal server or host as to whether or not congestion has occurred.

The terminal server or host the adjusts the transmission rate of packets having a low priority based on whether the congestion has occurred on a communication network, thereby providing stable packet transmission in the communication network.

A communication network including the conventional router includes at least one host, such as a Personal Computer (PC), connected to an Ethernet switch which is matched again to a router having a small or medium capacity. Furthermore, at least one server which stores, searches and manages information in connection with the plurality of hosts is matched to a router having a large capacity.

The small or medium capacity router interacting with the Ethernet switch is connected again to the large capacity router, and then to a Wide Area Network (WAN).

The small or medium capacity router and the large capacity router are devices functioning to forward received packets so that the received packets can be stably transmitted to a destination. These routers parse and find an optimal route (corresponding port/link) between the hosts and the servers through a routing protocol and forward the packets through the found route, so as to prevent a bottle-neck section of performance from being generated.

Furthermore, the routers find the optimal route for the packet to be received according to operation of the routing protocol, and checks whether the port/link connected with the optimal route is congested or not.

Here, congestion of the port/link is generated when an amount of the packet to be transmitted through the port/link is increased beyond a predetermined value compared with a size of a buffer corresponding to the port/link.

In this case, the routers set a value of explicit congestion notification of the packet to be transmitted to a value of congested section occurrence notification. Then, the routers find a second route for the packet to be received according to operation of the routing protocol, and transmit the packet, for which the congested section occurrence notification value is set, through the second route.

Either the host or the server reads out an ECN field of the packet received from the routers or the Ethernet switch. When the congested section occurrence notification value is set in the ECN field, either the host or the server actively adjusts the transmission rating of the packet, thereby being capable of preventing burst traffic from being expanded in the communication in advance.

The router uses an Internet protocol (IP) layer independent of its lower layers: link and physical layers, so that various technologies can be applied to the link and physical layers. Among them, the most general technology applied to the link and physical layers is the 802.3 standard defined by the IEEE standardization group, wherein the 802.3 standard is typically called Ethernet.

Therefore, the IP layer is located based on the link and physical layers of IEEE 802.3. The routing protocol for performing operation of the router is operated on a higher portion of the IP layer, wherein the router forwards the received packet to a proper route, detects the congested section in the communication network, and notifies the detected result to the host or server located at an end of the communication network.

The router includes line interfaces, a routing controller and a buffer.

The line interfaces interface IP packets forwarded between the host and the server.

The routing controller temporarily stores the IP packets received through the line interface in the buffer, parses and finds an optimal route between the host and the server through operation of the routing protocol, and retransmits the packets stored temporarily in the buffer through the found optimal route.

A structure of the IP packet forwarded through the router includes an ECN field of the IP packet.

The ECN field is used to notify the host and the server located at the ends of the communication network of whether the congested section is generated in the communication network.

The ECN field is activated or inactivated usually by a Transmission Control Protocol (TCP). In other words, the host and the server which are intended to use the ECN confer with each other on whether to use the ECN when the TCP connection setup is initiated. After conferring with each other, a TCP packet has a value of the ECN field set to “01” or “10.”

When receiving the packet having the ECN field value set to “01/10, the routing controller checks whether an optimal route for the corresponding packet, i.e. a port/link of the line interface to forward the packet is congested or not.

When an amount of the packet being on standby for transmission at the port/link to forward the corresponding packet is increased beyond a predetermined value, the routing controller determines that the congested section is generated. As a result, the routing controller sets the ECN field value to “11,” finds a second route through operation of the routing protocol, and forwards the corresponding IP packet through the second route.

In this manner, a method of notifying that the congested section is generated in the communication network using the conventional ECN field must be followed by assumption that the communication network is established through the routers.

However, technology being on the rise currently is one of establishing a communication network centered on Ethernet equipment or equipment for a second layer (L2 layer) rather than the router or equipment for a third layer (L3 layer).

Therefore a function of detecting the congested section of the communication network through the ECN field designed on the basis of the router as the L3 layer equipment has no effect on the Ethernet equipment such as the Ethernet switch as the L2 layer equipment.

In connection with this situation, there is another problem in that there is no standard capable of giving notification of whether or not the congested section has occurred in a current Ethernet network or not to the host and the server located at the end of the communication network.

Thus, the host and the server located at the end of the Ethernet based communication network fail to recognize whether or not the congested section has occurred in the Ethernet network, thereby failing to actively control the transmission rating of the packet.

Consequently, this leads to another problem in that burst traffic is expanded within the Ethernet network and that the Ethernet equipment such as the Ethernet switch undergoes a loss caused by overflow of packets, so that the Quality of Service (QoS) of the entire Ethernet network is lowered.

Therefore, in a trend of the current communication network being gradually replaced from an IP network centered on the router to an Ethernet network centered on a macro-Ethernet, there is a need for a standard making it possible to recognize whether or not the Ethernet network is congested and to cope with this situation in a rapid manner.

### SUMMARY OF THE INVENTION

It is, therefore, an object of the present invention to provide a device and method for providing information on congestion of an Ethernet network enabling a server or host located at an end of an communication network to recognize whether or not a congested section of the communication network based on the Ethernet switch has occurred.

In order to accomplish these and other objects, the present invention provides a device comprising: line interfaces including an input port/link connected to a first communication network and an output port/link connected to a second communication network, the line interfaces adapted to interface packets transmitted and received via input and output ports; a controller adapted to set any one field of an Ethernet type code of a packet to a value of a congested section occurrence notification and to retransmit the set packet to the second communication network upon the first and second communication networks being equivalent to each other and the congestion occurring at the port/link intended to retransmit the received packet, and to set an Explicit Congestion Notification (ECN) field of the packet to the congested section occurrence notification value, to convert the received packet based on a format of the second communication network and to retransmit the converted packet to the second communication network upon the first and second communication networks being different from each other and the Ethernet type code of the received packet being set to the congested section occurrence notification value; and a buffer adapted to temporarily store the packet received from the first communication network.

In order to accomplish these and other objects, the present invention provides a device comprising: line interfaces including input and output ports and adapted to interface an Ethernet packet between an external device and an Ethernet switch via the input and output ports; a controller adapted to set an Explicit Congestion Notification (ECN) field of an Internet Protocol (IP) header of the Ethernet packet to a value of congested section occurrence notification and to retransmit the set Ethernet packet upon the congestion occurring at a port/link intended to retransmit the received Ethernet packet; andva buffer adapted to temporarily store the Ethernet packet received via the input port.

In order to accomplish these and other objects, the present invention also provides a device comprising: line interfaces including input and output ports and adapted to interface an Ethernet packet between an external device and an Ethernet switch via the input and output ports; a controller adapted to set any one field of an Ethernet type code of the Ethernet packet to a value of congested section occurrence notification and to retransmit the set Ethernet packet upon the congestion occurring at a port/link intended to retransmit the received Ethernet packet; and a buffer adapted to temporarily store the Ethernet packet received via the input port.

In order to accomplish these and other objects, the present invention further provides a device comprising: line interfaces including input and output ports and adapted to interface an Ethernet packet between an external device and an Ethernet switch via the input and output ports; a controller adapted to set any one field of an Ethernet type code to a value of congested section occurrence notification according to a class and to retransmit the set Ethernet packet upon the congestion occurring at a port/link intended to retransmit the received Ethernet packet; and a buffer adapted to temporarily store the Ethernet packet received via the input port.

In order to accomplish these and other objects, the present invention yet further provides a device comprising: line interfaces including an input port/link connected to first communication network and an output port/link connected to a second communication network, the line interfaces adapted to interface packets transmitted and received via the input and output ports; a controller adapted to set an Explicit Congestion Notification (ECN) field to the congested section occurrence notification value and to convert a received packet according to a format of the second communication network and to retransmit the converted packet to the second communication network upon an Ethernet type code of the packet received from the first communication network being set to a value of congested section occurrence notification; and a buffer adapted to temporarily store the packet received from the first communication network.

In order to accomplish these and other objects, the present invention still further provides a method comprising: determining whether or not a packet received from a first communication network supports a function of congested section occurrence notification; determining whether or not a congested section has occurred at a port/link intended to retransmit the packet upon a determination that the packet supports the congested section occurrence notification function; setting the congested section occurrence notification value of the received packet upon a determination that the congested section has been generated at the port/link intended to retransmit the packet; and re-transmitting the received packet to a second communication network.

In order to accomplish these and other objects, the present invention further provides a method comprising: determining whether or not a function of congested section occurrence notification has been activated by reading out an Explicit Congestion Notification (ECN) field of a received Ethernet packet; determining whether or not a congested section has been generated at a port/link intended to retransmit the Ethernet packet upon a determination that the congested section occurrence notification function of the Ethernet packet has been activated; setting the ECN field of the received Ethernet packet to a value of congested section occurrence notification upon a determination that the congested section has been generated; and re-transmitting the Ethernet packet according to an Ethernet switching function of an Ethernet switch.

In order to accomplish these and other objects, the present invention also provides a method comprising: determining whether or not a received Ethernet packet includes an Ethernet type code having a function of congested section occurrence notification; determining whether or not the congested section occurrence notification function has been activated by reading out any one field of the Ethernet type code of the received Ethernet packet; determining whether or not a congested section has occurred at a port/link intended to retransmit the Ethernet packet upon a determination that the congested section occurrence notification function of the Ethernet packet has been activated; setting the any one field of the Ethernet type code of the received Ethernet packet to a value of congested section occurrence notification upon a determination that the congested section has been generated; and re-transmitting the Ethernet packet according to an Ethernet switching function of an Ethernet switch.

In order to accomplish these and other objects, the present invention yet also provides a method comprising: determining whether or not a received Ethernet packet includes an Ethernet type code having a function of congested section occurrence notification according to a class; determining whether or not the congested section occurrence notification function has been activated by reading out any one field of the Ethernet type code of the received Ethernet packet; determining whether or not a congested section has occurred at a port/link intended to retransmit the Ethernet packet upon a determination that the congested section occurrence notification function of the Ethernet packet has been activated; setting the any one field of the Ethernet type code of the received Ethernet packet to a value of congested section occurrence notification according to the class upon a determination that the congested section has occurred; and re-transmitting the Ethernet packet according to an Ethernet switching function of the Ethernet switch.

Lastly, in order to accomplish these and other objects, the present invention provides a method comprising: determining whether or not a received Ethernet packet includes an Ethernet type code having a function of congested section occurrence notification; determining whether or not any one field of the Ethernet type code of the received Ethernet packet has been set to a value of congested section occurrence notification; setting an Explicit Congestion Notification (ECN) field of the Ethernet packet to the congested section occurrence notification value upon a determination that the any one field of the Ethernet type code of the received Ethernet packet has been set to the congested section occurrence notification value; converting the Ethernet packet into a format of a second communication network; and re-transmitting the converted Ethernet packet to the second communication network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a communication network including a router;

FIG. 2 is a view of a conceptual internal protocol hierarchical structure of the router of FIG. 1;

FIG. 3 is a block diagram of an internal configuration of the router of FIG. 1;

FIG. 4 shows a structure of an IP packet forwarded through the router of FIG. 1;

FIG. 5 is a block diagram of a communication network including an Ethernet switch in accordance with an embodiment of the present invention;

FIG. 6 is a view of a conceptual internal protocol structure of an Ethernet switch in accordance with an embodiment of the present invention;

FIG. 7 is a block diagram of an Ethernet switch in accordance with an embodiment of the present invention;

FIG. 8 is a view of a frame structure of an Ethernet packet forwarded through an Ethernet switch in accordance with an embodiment of the present invention;

FIG. 9 is a view of an Ethernet type code field depending on a kind of Ethernet packet forwarded through an Ethernet switch in accordance with an embodiment of the present invention;

FIG. 10 is a view of a link and buffer configuration of an Ethernet switch in accordance with an embodiment of the present invention;

FIG. 11 is a flowchart of a method of providing information on Ethernet network congestion in accordance with an embodiment of the present invention;

FIG. 12 is a view of a structure of a basic Ethernet type code field having a function of providing congestion information in accordance with an embodiment of the present invention;

FIG. 13 is a view of a structure of a corrected Ethernet type code field having a function of providing congestion information in accordance with an embodiment of the present invention;

FIG. 14 is a flowchart of a method of providing congestion information of an Ethernet network in accordance with an embodiment of the present invention;

FIG. 15 is a view of a structure of a basic Ethernet type code field having a function of providing congestion information according to a class in accordance with an embodiment of the present invention;

FIG. 16 is a view of a structure of a corrected Ethernet type code field having a function of providing congestion information according to a class in accordance with an embodiment of the present invention;

FIG. 17 is a flowchart of a method for providing information on Ethernet network congestion according to a class in accordance with an embodiment of the present invention;

FIG. 18 is a flowchart of a method for providing information on Ethernet network congestion in a different communication network in accordance with an embodiment of the present invention;

FIG. 19 is a view of a field structure of an extended Ethernet header; and

FIG. 20 is a view of a structure of an Ethernet length field to provide Ethernet network congestion information in accordance with an embodiment of the present invention.

### DETAILED DESCRIPTION OF THE INVENTION

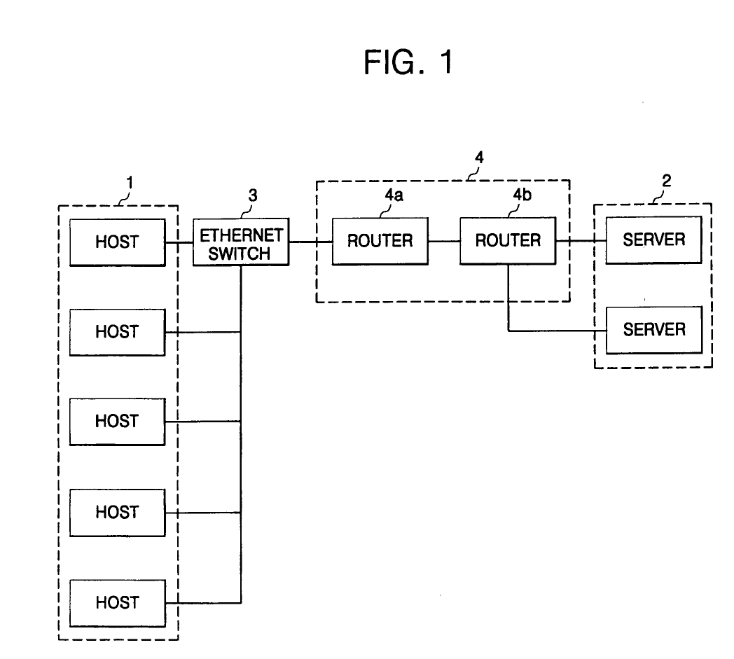

FIG. 1 is a block diagram of a communication network including a router. As shown in FIG. 1, at least one host 1, such as a Personal Computer (PC), is connected to an Ethernet switch 3 which is matched to a router 4a having a small or medium capacity. Furthermore, at least one server 2, which stores, searches and manages information in connection with the plurality of hosts 1, is matched to a router 4b having a large capacity.

The router 4a interacting with the Ethernet switch is connected to the large capacity router 4b, and then to a Wide Area Network (WAN)(not shown in FIG. 1).

The small or medium capacity router 4a and the large capacity router 4b are devices functioning to forward received packets so that the received packets can be stably transmitted to a destination. These routers parse and find an optimal route (corresponding port/link) between the hosts 1 and the servers 2 through a routing protocol and forward the packets through the found route, so as to prevent a bottle-neck section from occurring.

Furthermore, the routers 4a and 4b find the optimal route for the packet to be received according to operation of the routing protocol, and determine whether or not the port/link connected with the optimal route is congested.

Congestion of the port/link occurs when the number of packets to be transmitted through the port/link is increased beyond a predetermined value as compared with a size of a buffer corresponding to the port/link.

In this case, the routers set a value of explicit congestion notification of the packet to be transmitted to a value of congested section occurrence notification. Then, the routers find a second route for the packet to be received according to operation of the routing protocol, and transmit the packet, for which the congested section occurrence notification value has been set, through the second route.

Either the host 1 or the server 2 reads out an ECN field of the packet received from the routers 4a or 4b or the Ethernet switch 3. When the congested section occurrence notification value has been set in the ECN field, either the host 1 or the server 2 actively adjusts the transmission rate of the packet, thereby preventing in advance burst traffic from being expanded in the communication.

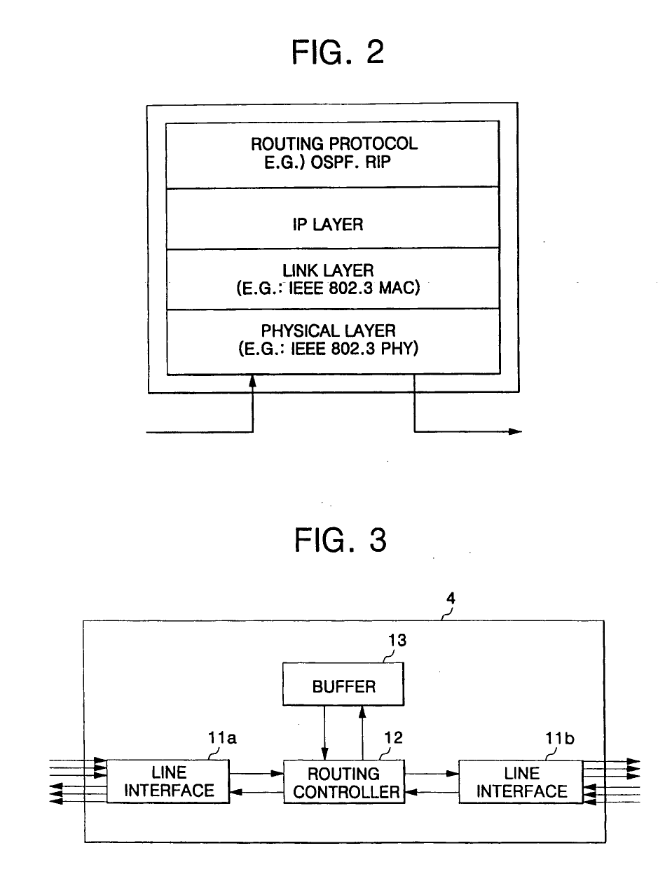

A protocol used in the router 4 is as shown in FIG. 2, wherein an Internet Protocol (IP) layer is independent of its lower layers, that is, link and physical layers, so that various technologies can be applied to the link and physical layers. Among them, the most general technology applied to the link and physical layers is the 802.3 standard defined by the IEEE standardization group, wherein the 802.3 standard is typically called Ethernet.

A Therefore, the IP layer is located based on the link and physical layers of IEEE 802.3. The routing protocol for performing operations of the router 4 is operated on a higher portion of the IP layer, wherein the router 4 forwards the received packet to a proper route, detects the congested section in the communication network, and provides the detected result to the host or server located at an end of the communication network.

FIG. 3 is a block diagram of the router of FIG. 1, wherein the router 4 includes line interfaces 11a and 11b, a routing controller 12 and a buffer 13.

The line interfaces 11a and 11b interface IP packets forwarded between the host 1 and the server 2.

The routing controller 12 temporarily stores the IP packets received through the line interface 11a in the buffer 13, parses and finds an optimal route between the host 1 and the server 2 through operation of the routing protocol, and retransmits the packets stored temporarily in the buffer 3 through the found optimal route.

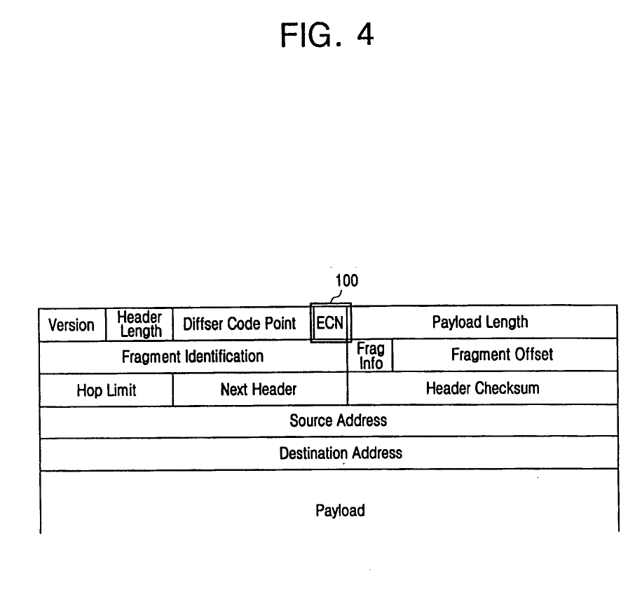

A structure of the IP packet forwarded through the router 1 is configured as in FIG. 4. A particular area of concern of the present invention is an ECN field of the IP packet, wherein the ECN field is indicated by a reference number 100 in FIG. 4.

The ECN field 100 is used to notify the host 1 and the server 2 located at the ends of the communication network as to whether or not congested section has occurred in the communication network.

A The ECN field 100 is activated or inactivated usually by a Transmission Control Protocol (TCP). In other words, the host 1 and the server 2 which are intended to use the ECN confer with each other on whether to use the ECN when the TCP connection setup is initiated. After conferring with each other, a TCP packet has a value of the ECN field set to “01” or “10.”

A When receiving a packet having the ECN field value set to “01/10, the routing controller 12 determines whether or not an optimal route for the corresponding packet, i.e. a port/link of the line interface 11b to forward the packet, is congested.

When an amount of time that the packet has been on standby for transmission at the port/link to forward the corresponding packet has increased beyond a predetermined value, the routing controller 12 determines that a congested section has occurred. As a result, the routing controller 12 sets the ECN field value to “11,” finds a second route through operation of the routing protocol, and forwards the corresponding IP packet through the second route.

An apparatus and method for providing Ethernet network congestion information is described below with reference to the accompanying drawings.

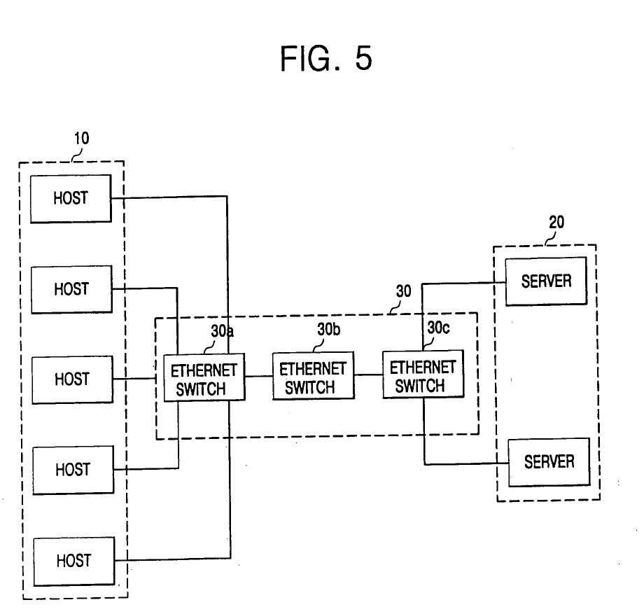

FIG. 5 is a block diagram of a communication network including an Ethernet switch in accordance with an embodiment of the present invention. As shown in FIG. 5, the network connection through the Ethernet switch includes at least one host or PC 10, at least one server 20 and at least one Ethernet switch 30.

The hosts or PCs 10 are connected to an Ethernet switch 30a, which is matched again to the Ethernet switch 30b having a small or medium capability. Furthermore, the servers 20 are connected to a plurality of hosts 10 and matched to the Ethernet switch 30c having a large capability.

The small or medium capability Ethernet switch 30b and the large capability Ethernet switch 30c parse a packet received through an Ethernet switching function to find an optimal route, and then switch the Ethernet packet to the found route.

Furthermore, these Ethernet switches 30a-30c determine whether or not a port/link corresponding to the optimal route of the packet to be forwarded is congested.

As a result of the determination by the Ethernet switches 30a-30c, when a congested section occurs, the Ethernet switches 30a-30c set a value of providing information as to the occurrence of congestion for either an Explicit Congestion Notification (ECN) field of an IP header of the packet to be forwarded or one region of an Ethernet type code of an Ethernet header.

A Then, the Ethernet switches 30a-30c find a second route to forward the packet for which the congested section occurrence notification value has been set through the Ethernet switching function, and then the packet is forwarded through the second route.

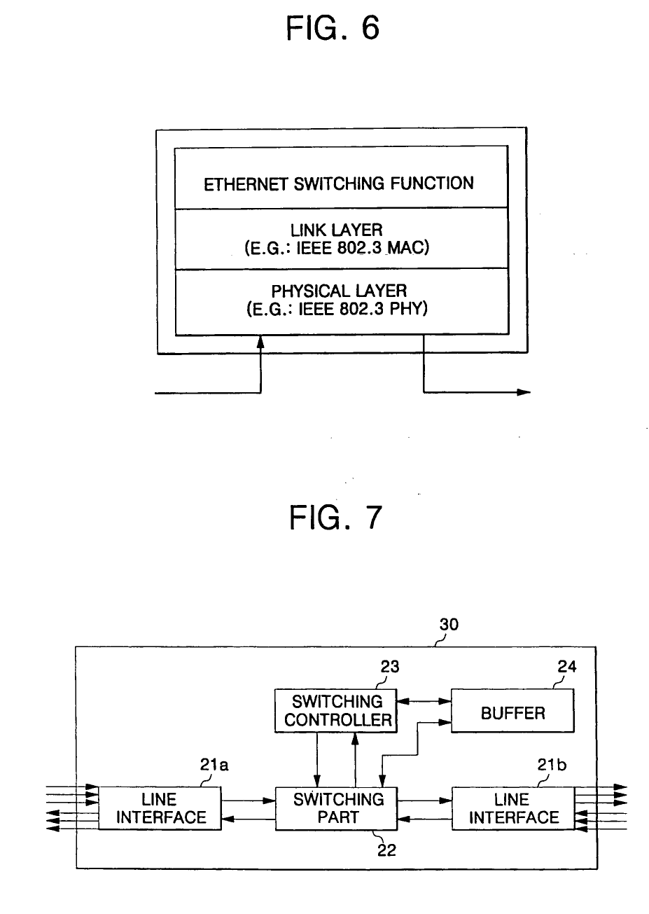

A protocol used in the Ethernet switches 30a-30c is as shown in FIG. 6, wherein an IEEE 802.3 standard, as the technology most generally used for link and physical layers, is used for lower link and physical layers, and an Ethernet switching function of switching the received packet to a proper route operates on the higher portion of the link layer.

FIG. 7 is a block diagram of an Ethernet switch in accordance with an embodiment of the present invention. As shown in FIG. 7, the Ethernet switch 30 includes line interfaces 21a and 21b, a switching part 22, a switching controller 23 and a buffer 24.

A The line interfaces 21a and 21b are included in each port/link which is connected to external equipment such as the host or PC 10, the server 20 and other Ethernet switches, and automatically set a transfer rate of the Ethernet packet of the external equipment supporting various transfer rates to be compatible with the transfer rate supported by the Ethernet switch 30. Furthermore, the line interfaces 21a and 21b interface the Ethernet packet which is forwarded between the external equipment connected through each port/link and the Ethernet switch 30.

A The switching part 22 senses whether a new Ethernet packet has been received through the line interface 21a, and switches the Ethernet packet which has been temporarily stored in the buffer 24 to the corresponding port/link according to a control signal transmitted from the switching controller 23.

A The switching controller 23 senses whether the new Ethernet packet has been received through the switching part 22. If the new Ethernet packet has been received, the switching controller 23 stores the received Ethernet packet in the buffer 24, and finds an optimal route between the host 10 and the server 20 through the Ethernet switching function, namely, the port/link to re-transmit the received Ethernet packet.

Then, the switching controller 23 transmits the control signal to the switching part 22 so as to re-transmit the Ethernet packet which has been temporarily stored in the buffer through the found port/link.

Furthermore, the switching controller 23 determines whether or not the port/link to re-transmit the received Ethernet packet is congested. When a congested section is generated at the port/link to re-transmit the Ethernet packet, the switching controller 23 sets information indicating that a congested section has occurred at the corresponding Ethernet switch by using bits of the ECN field or another field of the Ethernet switch 30. This will be described below in more detail.

The buffer 24 stores the Ethernet packet received through the port/link of the line interface 21a for a while, and can be freely positioned within the input or output port/link of the line interface 21a, the switching controller 23 or the switching part 22.

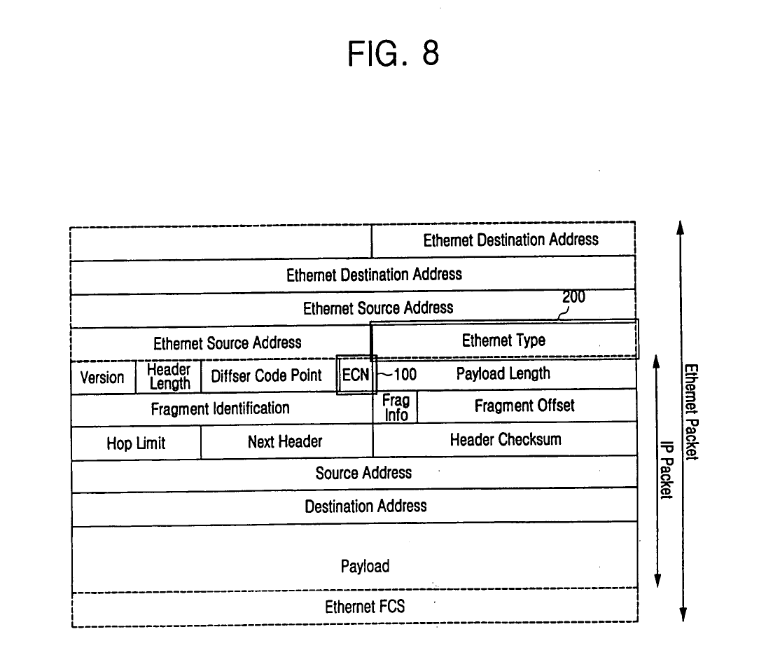

FIG. 8 shows a frame structure of an Ethernet packet forwarded through an Ethernet switch in accordance with the present invention, wherein the Ethernet frame has an IP packet contained in a payload. The present invention is concerned with an ECN field 100 of the IP packet, and an Ethernet type code field 200 of an Ethernet header.

The ECN field 100 is used in the same fashion as the ECN field of FIG. 4, while the Ethernet type code field 200, as an Ethernet header added when the Ethernet packet is generated, indicates the protocol used with a certain higher layer of the Ethernet layer, i.e.—the L3 layer.

The Ethernet type code field 200 can be assigned a designated value by authorization of an IEEE standard group when a business enterprise is necessary to develop an application program for the L3 layer or more.

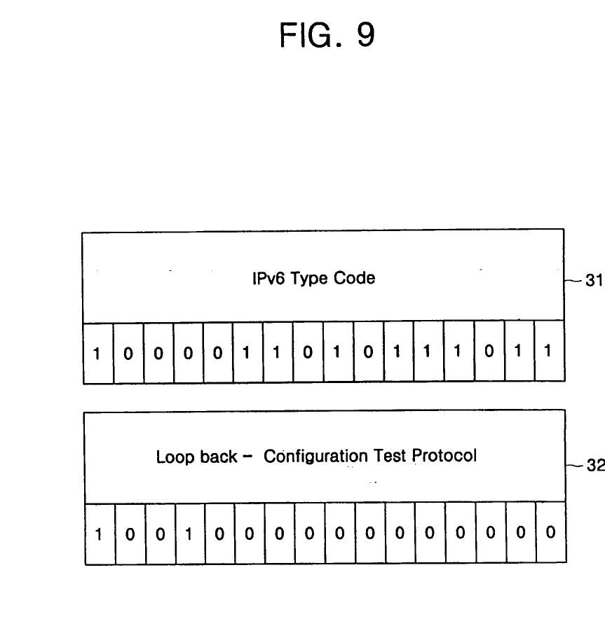

For reference, the value of the Ethernet type code field is assigned a value of “1000011010111011” as represented by a reference number 31 of FIG. 9 when the protocol used for the L3 layer is IPv6 (IP version 6), and a value of “1001000000000000” as represented by a reference number 32 of FIG. 9 when the protocol used by the L3 layer is a loop-back configuration test protocol.

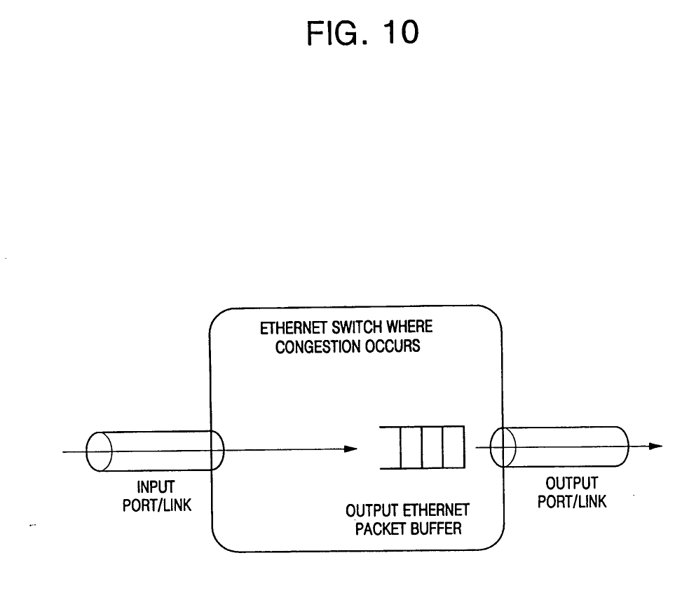

FIG. 10 is a view of a link and buffer configuration of an Ethernet switch in accordance with an embodiment of the present invention. In general, the Ethernet switch 30 has input and output ports/links and buffers for each port/link. The buffers can be positioned within the input port/link, the output port/link or the Ethernet switch.

When packets exceeding a size of the corresponding buffer continue to be transmitted from the host 10 or server 20 to the Ethernet switch 30, the Ethernet switch 30 performs a procedure of automatically discarding the packets beyond its processing capability. Accordingly, received packets are lost within the Ethernet switch 30.

For this reason, the present invention generally proposes four methods for detecting the congested section of the Ethernet switch and informing the host and server connected to the Ethernet network of the detected result.

Firstly, the Ethernet switch 30 is to recognize the ECN field 100 of the IP header, the L3 layer, like the router 4 and then to notify whether or not the Ethernet network is congested using the ECN field.

Secondly, the Ethernet switch 30 is to arbitrarily define a field similar to the ECN field 100 of the IP header using a specific field of the Ethernet header, namely the Ethernet type code field 200, and then to notify whether or not the Ethernet network is congested using the arbitrarily defined field.

Thirdly, one for complementing even the conventional ECN field, the Ethernet switch 30 is to differentially notify whether or not the Ethernet network is congested according to a priority of the forwarded packet using a specific field of the Ethernet header, namely the Ethernet type code field 200.

Finally, the Ethernet switch 30 is to notify whether or not a congested section of a communication network has occurred from a switch or router located between different communication networks.

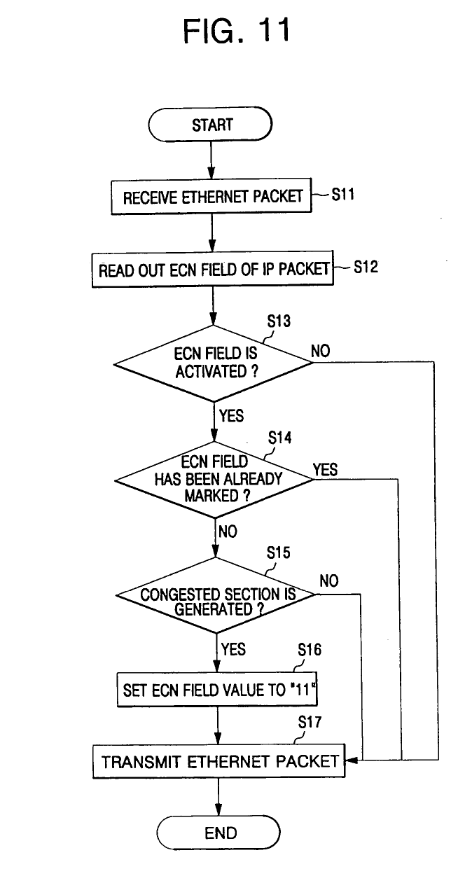

FIG. 11 is a flowchart of a first method, specifically, for notifying the occurrence of a congested section between Ethernet switches by direct use of an ECN field of an IP packet at the Ethernet switch according to technology of the present invention.

It is sensed whether or not a new Ethernet packet has been received(S11). When the new Ethernet packet has been received, the ECN field of the IP packet is read out of an Ethernet frame of the received Ethernet packet (S12).

At this point, the ECN field is typically activated or inactivated by a Transmission Control Protocol (TCP). In other words, both the host and the server, which intend to use the ECN field, confer with each other about use of the ECN field when the TCP connection setup is initiated. Then, when intending the ECN field to be used after that conference, a value of the ECN field is set to “01” or “10.”

A determination is made as to whether or not the ECN field has been activated (S13). If the ECN field has been activated, a determination is made as to whether or not the ECN field has been already marked with “11” as a value of notifying the occurrence of the congested section (S14). However, if the ECN field is inactivated, an optimal route is found according to the Ethernet switching function, and then an Ethernet packet received through the port/link corresponding to the optimal route is forwarded (S17).

The fact that the ECN field has been already marked with “11” as the congested section occurrence notification value means that the congested section has occurred at the preceding Ethernet switch and so the congested section occurrence notification value has been set by the preceding Ethernet switch.

If the ECN field is not marked with the congested section occurrence notification value, a determination is made as to whether or not the port/link corresponding to the optimal route for the received Ethernet packet is congested (S15). As a result of the determination, if the port/link for the received Ethernet packet is not congested, the received Ethernet packet is forwarded to the exterior through the corresponding port/link without changing the ECN field value (S17).

However, if the port/link for the received Ethernet packet is congested, the ECN field value is set to “11” as the congested section occurrence notification value (S16). Then, a second route is found through the Ethernet switching function, and the received Ethernet packet is forwarded to the exterior through the port/link corresponding to the second route (S17).

Prior to describing the second method using a specific field of the Ethernet header, the following detailed description will be begin with the Ethernet type code field to be used in the present invention.

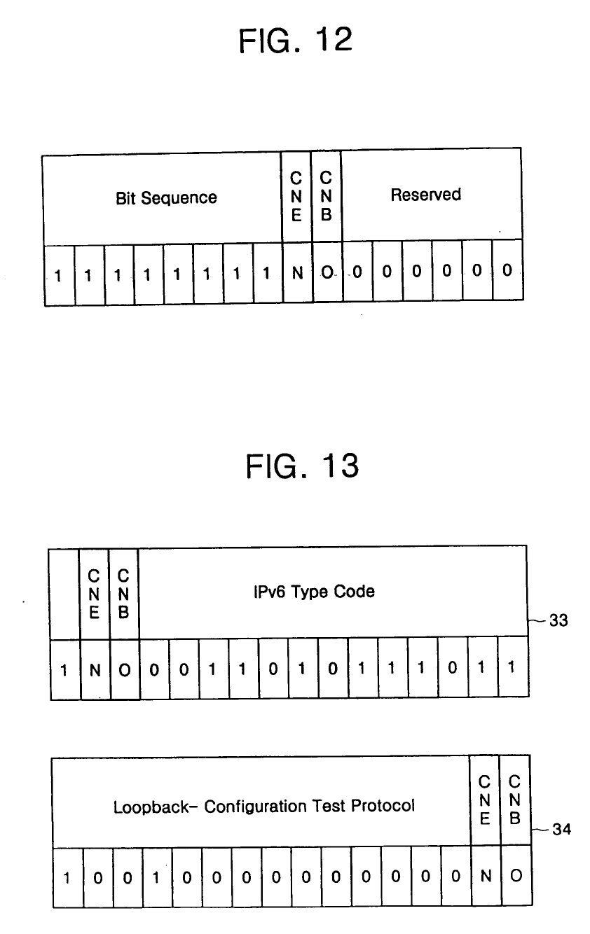

The present invention can be basically required for a structure of the Ethernet type code field of FIG. 12.

Referring to FIG. 12, the Ethernet type code field consisting of 16 bits in total defines a bit sequence field (8 bits), a preserved field (6 bits), a Congestion Notification Enable (CNE) field (1 bit) and a Congestion Notification Bit (CNB) field (1 bit).

The bit sequence field is stored with a bit sequence having a fixed pattern in order to indicate the Ethernet packet including a function of notifying the occurrence of the congested section in the Ethernet network. When bit sequence field includes the congested section occurrence notification function, the bit sequence is set to “111111 11.”

The CNE field is stored with information as to whether or not the congested section occurrence notification function of the Ethernet packet has been activated. The CNE field has a bit value set to “1” when activating the congested section occurrence notification function for the corresponding Ethernet packet. However, the CNE field has the bit value set to “0” when not activating the congested section occurrence notification function for the corresponding Ethernet packet.

The CNB field includes information as to whether or not a congested section has occurred. When the congested section has occurred, the CNB field is set to “1.”

However, the structure of the Ethernet type code field of FIG. 12 is employed with the simplest method proposed in the present invention. When the Ethernet type code field for which a value of a higher protocol has already been set is to be used, the Ethernet type code field having the following structure is used. Reference number 33 of FIG. 13 is a structure of the Ethernet type code field when utilizing IPv6 on the Ethernet, and reference number 34 is a structure of the Ethernet type code field when using protocols which are independently defined by other respective business enterprises on the Ethernet.

When utilizing the IPv6 of reference number 33 of FIG. 13, the Ethernet type code field is adapted to use a second bit field as the CNE field and to use a third bit field as the CNB field. The CNE and CNB fields have the same use as those of FIG. 12, and so a detailed description thereof has been omitted.

When using protocols which are independently defined by other respective business enterprises on the Ethernet, the Ethernet type code field as of reference number 34 of FIG. 13 has a packet structure as follows.

When a loop-back configuration test protocol is driven on a higher portion of the Ethernet, two bit fields which are assigned in close proximity to each other (not set to “1” or not used) like the reference number 34 of FIG. 13 should be used, wherein the two bit fields are used as the CNE and CNB fields.

In this case, the CNE and CNB fields have the same use as those of FIG. 12, and a detailed description thereof has been omitted.

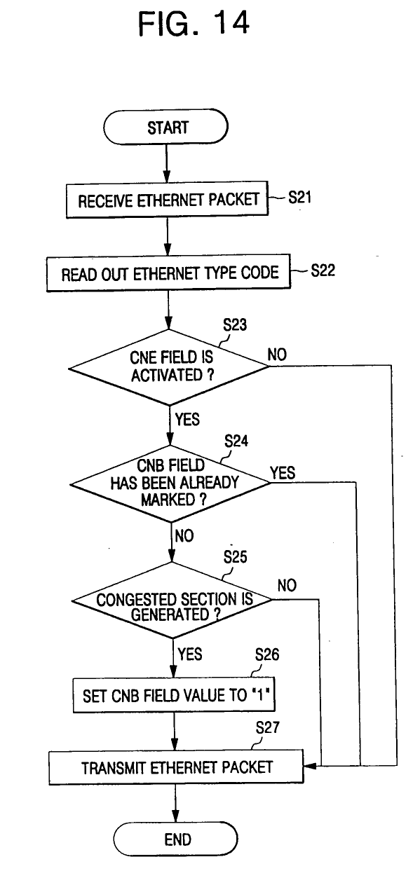

FIG. 14 is a flowchart of the second method of using the specific field of the Ethernet header described above, wherein the second method indicates whether or not a congested section has occurred between Ethernet switches using the CNE and CNB fields of the Ethernet type code field.

It is assumed that the Ethernet packet should use the Ethernet type code field.

A determination is made as to whether or not a new Ethernet packet has been received (S21). If the new Ethernet packet has been received, the received Ethernet packet has its Ethernet type code read out (S22).

The Ethernet packet supporting the congested section occurrence notification function gets the CNE field of the Ethernet type code field set to “1,” while the Ethernet packet not supporting the congested section occurrence notification function gets the CNE field of the Ethernet type code field set to “0.”

A determination is made as to whether or not the received Ethernet packet supports the congested section occurrence notification function by reading out a value of the CNE field of the Ethernet type code field (S23).

If the received Ethernet packet supports the congested section occurrence notification function, a determination is made, by reading out the CNE field value, as to whether or not a value indicating the occurrence of the congested section has already been marked by the preceding Ethernet switch (S24).

By contrast, if the received Ethernet packet does not support the congested section occurrence notification function, an optimal route is found based on the Ethernet switching function, and the received Ethernet packet is forwarded as is to the exterior through the port/link corresponding to the optimal route (S27).

As a result of the determination, when the CNE field value is set to “0” and the congested section occurrence notification value is not marked, the optimal route for the received Ethernet packet is found through the Ethernet switching function, and a determination is made as to whether or not congestion of the port/link corresponding to the found route has occurred (S25).

As a result of the checking, if congestion of the port/link corresponding to the found route has occurred, the CNB field value of the received Ethernet packet is set to “1” as the congested section occurrence notification value (S26). Then, a second route is found through the Ethernet switching function, and the received Ethernet packet is forwarded to the exterior through the port/link corresponding to the second route (S27).

However, if congestion of the port/link corresponding to the found route has not occurred, the received Ethernet packet is forwarded as is to the exterior through the corresponding port/link without modification of the CNB field value (S27).

The following third method is one of complementing drawbacks using the ECN field of the IP packet and the CNE/CNB field of the Ethernet type code field. In other words, when the ECN field and the CNE/CNB field of the Ethernet type code field are used, the third method is adapted to inform whether or not the congested section according to a class is present.

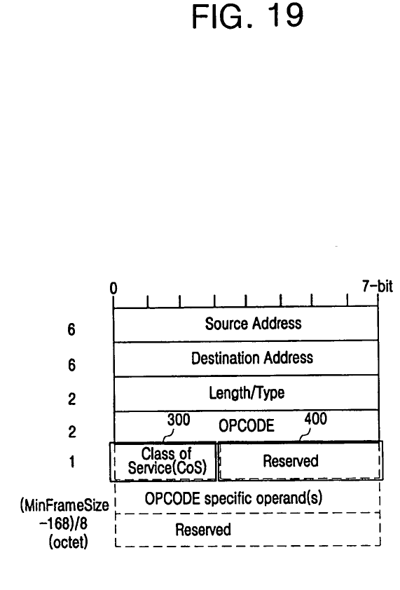

The Ethernet sorts Class of Service (CoS) of each packet using a CoS field 300 of an extended Ethernet packet header as in FIG. 19. In other words, a priority is provided based on a level of service of a forwarded packet, and a differentiated service is provided according to the class on the basis of the priorities of each packet.

Thus, the third method is useful when the Ethernet sorts and processes the received packets based on their priorities, and has independent buffers with respect to each group of packets sorted on the basis of the priorities.

In other words, when the buffers are independently sorted according to class on the basis of the priorities, a notification is provided only to the class having the corresponding priority as to whether or not a congested section has occurred. Furthermore, this can be applied to using restricting traffic of the packets that have a priority that is lower than a specific priority.

The Ethernet type code field to be used in the present invention is described below in detail, followed by a description of the third method using the specific field of the Ethernet header.

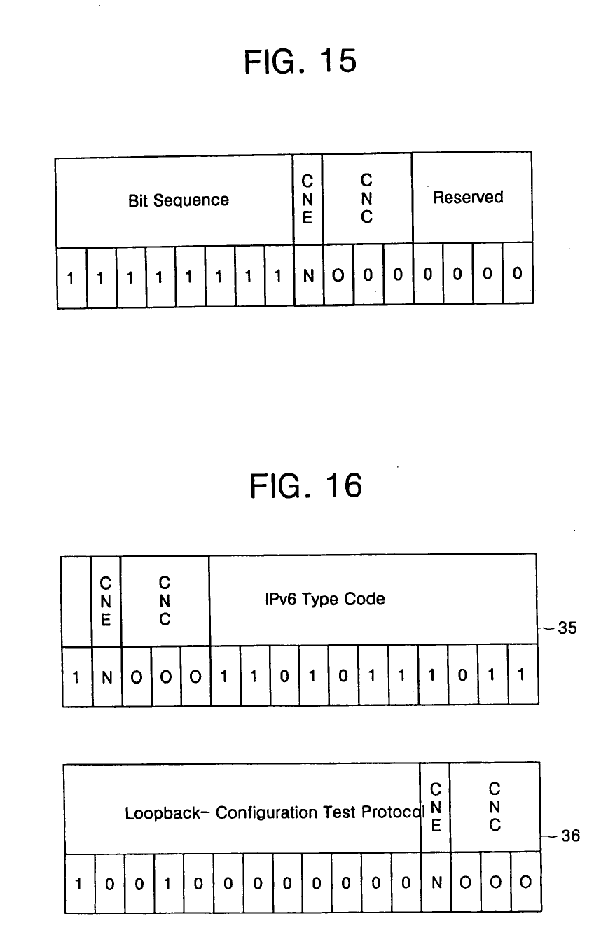

In the present invention, it is recommended to basically use the structure of the Ethernet type code field as in FIG. 15.

Referring to FIG. 15, the Ethernet type code field consisting of 16 bits in total defines a bit sequence field (8 bits), a preserved field (4 bits), a CNE (Congestion Notification Enable) field (1 bit) and a CNC (Congestion Notification Class) field (3 bits).

Both the bit sequence field and the CNE field have the same use as those of FIG. 12, and so a detailed description thereof has been omitted.

The CNC field stores information as to the priority class of a received Ethernet packet when a congested section occurs.

In the present invention, the CNC field is assigned 3 bits according to a value of the priority class of the present Ethernet packet similar to the CoS 300 of FIG. 19. However, when a bit number is changed depending on a change of future standards or environment, the bit number of the CNC field can be assigned and used in the same manner as the foregoing.

FIG. 15 is a view of a pattern according to an embodiment of the present invention. As to the Ethernet type code field which has been already defined in a different manner from that of FIG. 15, a corrected method can be used when information of the congested section is intended for transmission.

Referring to FIG. 16, Ethernet type code field 35 indicates a structure when IPv6 is utilized on the Ethernet, and Ethernet type code field 36 indicates a structure when protocols, which are independently defined by other respective business enterprises, are used on the Ethernet.

In the case of utilizing the IPv6 as in Ethernet type code field 35 of FIG. 16, the Ethernet type code field is adapted to lease a second bit field and to use it as the CNE field and to lease third, fourth and fifth bit fields and to use them as the CNC field. The CNE and CNC fields have the same use as those of FIG. 15, and so a detailed description thereof has been omitted.

When using protocols, which are independently defined by other respective business enterprises, on the Ethernet, the Ethernet type code field is configured as in Ethernet type code field 36 of FIG. 16.

Specifically, when a loop-back configuration test protocol is driven on a higher portion of the Ethernet, four bit fields which are assigned in close proximity to each other (not set to “1” or not used) as in Ethernet type code field 36 of FIG. 16 should be used, wherein the four bit fields are leased and used as the CNE and CNC fields. In this case, the CNE and CNC fields have the same use as those of FIG. 15, and so a detailed description thereof has been omitted.

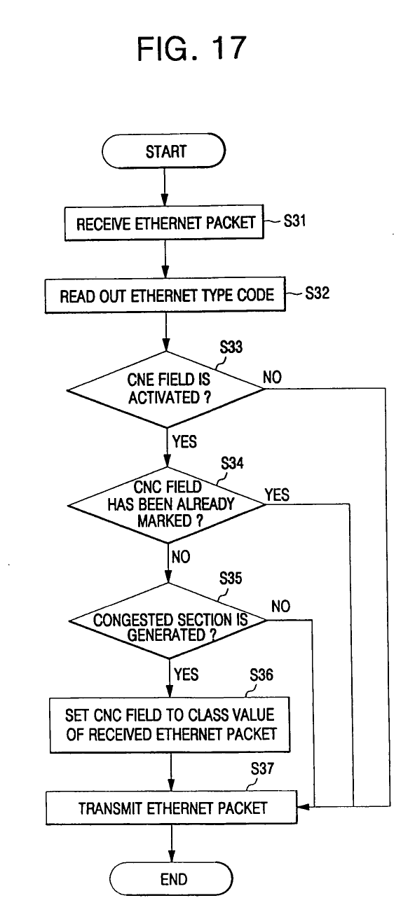

FIG. 17 is a of a method of using the specific field of the Ethernet header described up to now and simultaneously complementing a drawback of a conventional ECN, wherein the method notifies whether a congested section has occurred between Ethernet switches using the CNE and CNC fields of the Ethernet type code field.

It is assumed that the Ethernet packet should use the Ethernet type code field.

A determination is made as to whether a new Ethernet packet has been received (S31). If a new Ethernet packet has been received, the received Ethernet packet has its Ethernet type code read out (S32).

The Ethernet packet supporting the congested section occurrence notification function gets the CNE field of the Ethernet type code field set to “1,” while the Ethernet packet not supporting the congested section occurrence notification function gets the CNE field of the Ethernet type code field set to “0.”

A determination is made as to whether or not the received Ethernet packet supports the congested section occurrence notification function by reading out a value of the CNE field of the Ethernet type code field (S33).

If the received Ethernet packet supports the congested section occurrence notification function, a determination is made, by reading out the CNE field value, as to whether or not a value of notifying occurrence of the congested section has been already marked by the preceding Ethernet switch (S24).

In contrast, if the received Ethernet packet does not support the congested section occurrence notification function, an optimal route is found based on the Ethernet switching function, and the received Ethernet packet is forwarded as is to the exterior through the port/link corresponding to the optimal route (S37).

As a result of the checking, when the CNC field value is set to “000” and so the congested section occurrence notification value is not marked, the optimal route for the received Ethernet packet is found through the Ethernet switching function, and then a determination is made as to whether or not congestion of the port/link corresponding to the found route has occurred (S35).

On the other hand, when the CNC field value is set to any one of “001-111” which is the congested section occurrence notification value, it is confirmed that the congested section has already been generated by the preceding Ethernet switch and that the congested section occurrence notification value is marked, the corresponding Ethernet packet is forwarded as is to the exterior (S37).

As a result of the checking, if congestion of the port/link corresponding to the found route has occurred, the CNC field of the received Ethernet packet is set to a value of class according to a priority of the received Ethernet packet and marked with the congested section occurrence notification value according to the class (S36). Then, a second route is found through the Ethernet switching function, and the received Ethernet packet is forwarded to the exterior through the port/link corresponding to the second route (S37).

Furthermore, the present invention is adapted to support the congested section occurrence notification function even in the following case by combining the second and third methods unlike the foregoing method.

This is applied to the case that specific switch equipment receives the Ethernet packet as an input, but has to transmit a modification, which is changed in a form of Packet over SONET (POS) or IP over ATM (IPoA) rather than the Ethernet packet, as an output.

Even in this case, since a standard supporting the congested section occurrence notification function of a communication network is not yet present, the host or server located at the end of the communication network cannot receive the congested section occurrence notification of the communication network notification.

For this reason, the present invention provides a fourth method for setting a value of the ECN field based on information stored in the CNB/CNC fields in connection with the second and third methods.

The fourth method sets the ECN field value of an IP field of a packet to be forwarded according to values of the CNB/CNC fields, each of which is stored with the congested section occurrence notification value of the Ethernet packet inputted at an intermediate switch or router.

In the third method, the class according to the priority of the packet causing the congested section is provided as information through the CNC field. In the fourth method, it is obtained through information on the CNC field only whether the congested section occurs, which is applied as the ECN field value.

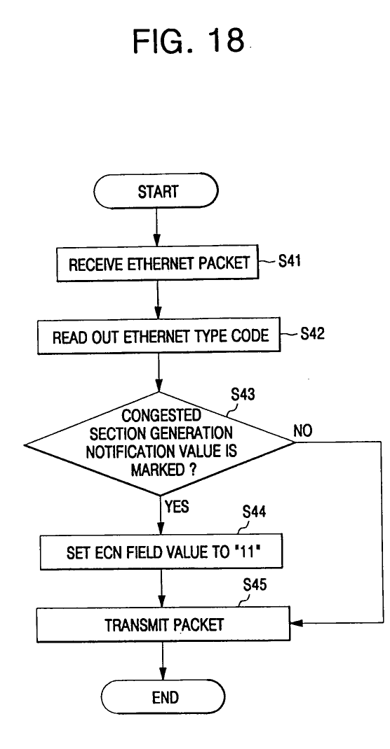

FIG. 18 is a flowchart of the fourth method of setting the ECN field value based on information of the CNB/CNC fields proposed in the above-mentioned second and third methods.

It is assumed that the Ethernet packet inputted into a specific Ethernet switch should basically make use of the Ethernet type code field.

A determination is made as to whether a new Ethernet packet has been received (S41). If a new Ethernet packet has been received, the received Ethernet packet has its Ethernet type code read out (S42).

A determination is made as to whether or not the CNB or CNC field of the Ethernet type code has been marked with the congested section occurrence notification value or the congested section occurrence notification value according to the class (S43). If the CNB or CNC field of the Ethernet type code has been marked with the congested section occurrence notification value or the congested section occurrence notification value according to the class, the ECN field value of the IP packet is set to “11,” and it is notified that the congested section has occurred (S44).

In contrast, if the CNB or CNC field of the Ethernet type code has not been marked with the congested section occurrence notification value or the congested section occurrence notification value according to the class, the Ethernet packet gets only its format converted to be compatible with a format of an output terminal without a change of the ECN field value and then is transmitted to the Ethernet network or another communication network again.

The Ethernet packet having the converted ECN field value is converted to be compatible with the output terminal format, and then is transmitted to the Ethernet network or another communication network again (S45).

Finally, a method where the CNE/CNB fields and CNE/CNC fields utilized in the present invention are placed at another position of the Ethernet header can be considered.

A field structure of the Ethernet header extended for this purpose is as shown in FIG. 19. In other words, the field structure uses the above-mentioned Ethernet type code as a length field and then adds several fields. In this case, the present invention is adapted to lease and use a reserved field (5 bits) 400.

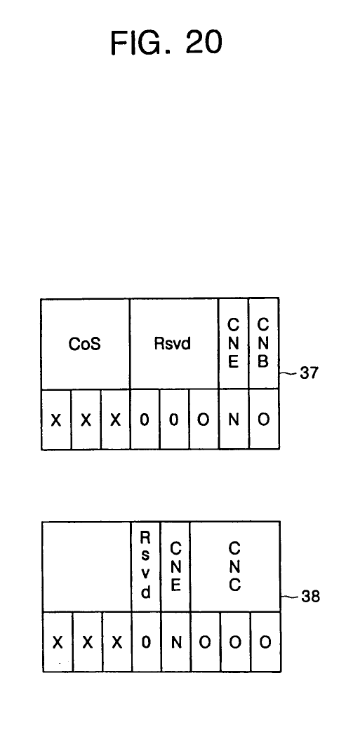

Referring to FIG. 20, element 37 is an example of leasing two bits of the reserved field (5 bits) 400 and utilizing the leased bits as the CNE and CNB fields, and element 38 is an example of leasing four bits of the reserved field (5 bits) and utilizing the leased bits as the CNE and CNB fields.

While the present invention has been described with reference to the exemplary embodiments, it should be understood to those skilled in the art that various other modifications and changes can be provided within the spirit and scope the present invention as recited in the following claims.

As can be seen from the foregoing, the present invention supports the host and the server to actively adjust the amount of packets to be transmitted by allowing the host and the server to recognize whether or not a congested section of the communication network has occurred. This makes it possible to not only reduce the duration of congestion resulting from a delay and a processing delay in the communication network, but also to prevent burst traffic from being generated within the communication network, and to provide stabilization of the communication network in the end.

1. A device comprising:
line interfaces including an input port/link connected to a first communication network and an output port/link connected to a second communication network, the line interfaces adapted to interface packets transmitted and received via input and output ports;
a controller adapted to set any one field of an Ethernet type code of a packet to a value of a congested section occurrence notification and to retransmit the set packet to the second communication network upon the first and second communication networks being equivalent to each other and the congestion occurring at the port/link intended to retransmit the received packet, and to set an Explicit Congestion Notification (ECN) field of the packet to the congested section occurrence notification value, to convert the received packet based on a format of the second communication network and to retransmit the converted packet to the second communication network upon the first and second communication networks being different from each other and the Ethernet type code of the received packet being set to the congested section occurrence notification value; and
a buffer adapted to temporarily store the packet received from the first communication network.

2. The device according to claim 1, wherein the first and second communication networks comprise Ethernet networks.

3. The device according to claim 1, wherein the controller sets the ECN field of an Internet Protocol (IP) header of the packet to the congested section occurrence notification value upon the first and second communication networks being Ethernet networks equivalent to each other and the congestion occurring at the port/link intended to retransmit the received packet.

4. The device according to claim 1, wherein the controller is adapted to insert the congested section occurrence notification value into the Ethernet type code according to a class based on a priority of the packet upon the first and second communication networks being Ethernet networks equivalent to each other and the congestion occurring at the port/link intended to retransmit the received packet.

5. The device according to claim 1, wherein the first communication network comprises an Ethernet network and the second communication network comprises any one of an IP network, a Packet over SONET (POS) network and an IP over ATM (IpoA) network.

6. A device comprising:
line interfaces including input and output ports and adapted to interface an Ethernet packet between an external device and an Ethernet switch via the input and output ports;
a controller adapted to set an Explicit Congestion Notification (ECN) field of an Internet Protocol (IP) header of the Ethernet packet to a value of congested section occurrence notification and to retransmit the set Ethernet packet upon the congestion occurring at a port/link intended to retransmit the received Ethernet packet; and
a buffer adapted to temporarily store the Ethernet packet received via the input port.

7. A device comprising:
line interfaces including input and output ports and adapted to interface an Ethernet packet between an external device and an Ethernet switch via the input and output ports;
a controller adapted to set any one field of an Ethernet type code of the Ethernet packet to a value of congested section occurrence notification and to retransmit the set Ethernet packet upon the congestion occurring at a port/link intended to retransmit the received Ethernet packet; and
a buffer adapted to temporarily store the Ethernet packet received via the input port.

8. The device according to claim 7, wherein the any one field of the Ethernet type code includes an Ethernet type code field having a Congestion Notification Enable (CNE) field and a Congestion Notification Bit (CNB) field, the CNE field indicating whether or not a function of the congested section occurrence notification of the Ethernet packet has been activated, and the CNB field indicating whether or not a congested section has occurred.

9. The device according to claim 7, wherein the controller is adapted to set values of the CNE and CNB fields of the Ethernet type code field to the congested section occurrence notification value upon the congestion occurring at the port intended to retransmit the Ethernet packet having the congested section occurrence notification function activated.

10. The device according to claim 8, wherein the controller is adapted to set values of the CNE and CNB fields of the Ethernet type code field to the congested section occurrence notification value upon the congestion occurring at the port intended to retransmit the Ethernet packet having the congested section occurrence notification function activated.

11. A device comprising:
line interfaces including input and output ports and adapted to interface an Ethernet packet between an external device and an Ethernet switch via the input and output ports;
a controller adapted to set any one field of an Ethernet type code to a value of congested section occurrence notification according to a class and to retransmit the set Ethernet packet upon the congestion occurring at a port/link intended to retransmit the received Ethernet packet; and
a buffer adapted to temporarily store the Ethernet packet received via the input port.

12. The device according to claim 11, wherein the any one field of the Ethernet type code includes an Ethernet type code field having a Congestion Notification Enable (CNE) field and a Congestion Notification Class (CNC) field, the CNE field indicating whether or not a function of the congested section occurrence notification of the Ethernet packet has been activated, and the CNC field indicating the class according a priority of the Ethernet packet in which a congested section occurs.

13. The device according to claim 11, wherein the controller is adapted to set values of the CNE and CNC fields of the Ethernet type code field to the congested section occurrence notification value according to the class upon the congestion occurring at the port intended to retransmit the Ethernet packet having the congested section occurrence notification function activated.

14. The device according to claim 12, wherein the controller is adapted to set values of the CNE and CNC fields of the Ethernet type code field to the congested section occurrence notification value according to the class upon the congestion occurring at the port intended to retransmit the Ethernet packet having the congested section occurrence notification function activated.

15. A device comprising:
line interfaces including an input port/link connected to first communication network and an output port/link connected to a second communication network, the line interfaces adapted to interface packets transmitted and received via the input and output ports;
a controller adapted to set an Explicit Congestion Notification (ECN) field to the congested section occurrence notification value and to convert a received packet according to a format of the second communication network and to retransmit the converted packet to the second communication network upon an Ethernet type code of the packet received from the first communication network being set to a value of congested section occurrence notification; and
a buffer adapted to temporarily store the packet received from the first communication network.

16. The device according to claim 15, wherein the first communication network comprises an Ethernet network and the second communication network comprises any one of an IP network, a Packet over SONET (POS) network and an IP over ATM (IpoA) network.

17. The device according to claim 15, wherein the controller is adapted to set the ECN field to the congested section occurrence notification value, to convert the packet according to the format of the second communication network and to retransmit the converted packet to the second communication network upon an Ethernet type code of the packet received from the first communication network being set to the congested section occurrence notification value according to a class.

18. A method comprising:
determining whether or not a packet received from a first communication network supports a function of congested section occurrence notification;
determining whether or not a congested section has occurred at a port/link intended to retransmit the packet upon a determination that the packet supports the congested section occurrence notification function;
setting the congested section occurrence notification value of the received packet upon a determination that the congested section has been generated at the port/link intended to retransmit the packet; and
re-transmitting the received packet to a second communication network.

19. The method according to claim 18, wherein the first and second communication networks are equivalent to each other.

20. The method according to claim 18, wherein setting the congested section occurrence notification value of the received packet includes setting an Explicit Congestion Notification (ECN) field of an Internet Protocol (IP) header to the congested section occurrence notification value.

21. The method according to claim 18, wherein determining whether or not a congested section has occurred at a port/link intended to retransmit the packet includes:
determining whether the packet supports the congested section occurrence notification function using an Ethernet type code of an Ethernet header; and
setting any one field of the Ethernet type code of the Ethernet header to the congested section occurrence notification value.

22. The method according to claim 19, wherein determining whether or not a congested section has occurred at a port/link intended to retransmit the packet includes:
determining whether the packet supports the congested section occurrence notification function using an Ethernet type code of an Ethernet header; and
setting any one field of the Ethernet type code of the Ethernet header to the congested section occurrence notification value.

23. The method according to claim 18, wherein setting the congested section occurrence notification value of the received packet includes:
determining whether the packet supports the congested section occurrence notification function according to a class on the basis of a priority of the received packet using an Ethernet type code of an Ethernet header; and
setting any one field of the Ethernet type code of the Ethernet header to the congested section occurrence notification value according to the class.

24. The method according to claim 18, wherein the first communication network is the Ethernet network and the second communication network is any one of an IP network, a Packet over SONET (POS) network and an IP over ATM (IpoA) network.

25. The method according to claim 18, wherein setting the congested section occurrence notification value of the received packet includes:
determining whether the congested section occurrence notification value has been set in any one field of an Ethernet type code of the packet;
setting an Explicit Congestion Notification (ECN) field of the packet to the congested section occurrence notification value upon a determination that the congested section occurrence notification value has been set in the packet; and
converting the packet into a format of the second communication network.

26. The method according to claim 18, wherein setting the congested section occurrence notification value of the received packet includes:
determining whether the congested section occurrence notification value according to a class has been set in any one field of an Ethernet type code of the packet;
setting an Explicit Congestion Notification (ECN) field of the packet to the congested section occurrence notification value upon a determination that the congested section occurrence notification value according to a class has been set in the packet; and
converting the packet into a format of the second communication network.

27. A method comprising:
determining whether or not a function of congested section occurrence notification has been activated by reading out an Explicit Congestion Notification (ECN) field of a received Ethernet packet;
determining whether or not a congested section has been generated at a port/link intended to retransmit the Ethernet packet upon a determination that the congested section occurrence notification function of the Ethernet packet has been activated;
setting the ECN field of the received Ethernet packet to a value of congested section occurrence notification upon a determination that the congested section has been generated; and
re-transmitting the Ethernet packet according to an Ethernet switching function of an Ethernet switch.

28. A method comprising:
determining whether or not a received Ethernet packet includes an Ethernet type code having a function of congested section occurrence notification;
determining whether or not the congested section occurrence notification function has been activated by reading out any one field of the Ethernet type code of the received Ethernet packet;
determining whether or not a congested section has occurred at a port/link intended to retransmit the Ethernet packet upon a determination that the congested section occurrence notification function of the Ethernet packet has been activated;
setting the any one field of the Ethernet type code of the received Ethernet packet to a value of congested section occurrence notification upon a determination that the congested section has been generated; and
re-transmitting the Ethernet packet according to an Ethernet switching function of an Ethernet switch.

29. The method according to claim 28, wherein the any one field of the Ethernet type code includes an Ethernet type code field having a Congestion Notification Enable (CNE) field and a Congestion Notification Bit (CNB) field upon the congested section occurring, the CNE field storing a value indicating that the congested section occurrence notification function of the Ethernet packet has been activated, and the CNB field storing the congested section occurrence notification value.

30. A method comprising:
determining whether or not a received Ethernet packet includes an Ethernet type code having a function of congested section occurrence notification according to a class;
determining whether or not the congested section occurrence notification function has been activated by reading out any one field of the Ethernet type code of the received Ethernet packet;
determining whether or not a congested section has occurred at a port/link intended to retransmit the Ethernet packet upon a determination that the congested section occurrence notification function of the Ethernet packet has been activated;
setting the any one field of the Ethernet type code of the received Ethernet packet to a value of congested section occurrence notification according to the class upon a determination that the congested section has occurred; and
re-transmitting the Ethernet packet according to an Ethernet switching function of the Ethernet switch.

31. The method according to claim 30, wherein the any one field of the Ethernet type code includes an Ethernet type code field having a Congestion Notification Enable (CNE) field and a Congestion Notification Class (CNC) field upon a determination that the congested section has occurred, the CNE field storing a value of notifying that the congested section occurrence notification function of the Ethernet packet has been activated, and the CNB field storing a value of the class according to a priority of the Ethernet packet as the congested section occurrence notification value according to the class.

32. A method comprising:
determining whether or not a received Ethernet packet includes an Ethernet type code having a function of congested section occurrence notification;
determining whether or not any one field of the Ethernet type code of the received Ethernet packet has been set to a value of congested section occurrence notification;
setting an Explicit Congestion Notification (ECN) field of the Ethernet packet to the congested section occurrence notification value upon a determination that the any one field of the Ethernet type code of the received Ethernet packet has been set to the congested section occurrence notification value;
converting the Ethernet packet into a format of a second communication network; and
re-transmitting the converted Ethernet packet to the second communication network.

33. The method according to claim 32, further comprising:
determining whether or not the received Ethernet packet includes the Ethernet type code having the congested section occurrence notification function according to a class;
determining whether or not the any one field of the Ethernet type code of the Ethernet packet has been set to the congested section occurrence notification value according to a class;
setting the ECN field of the Ethernet packet to the congested section occurrence notification value upon a determination that the any one field of the Ethernet type code of the Ethernet packet has been set to the congested section occurrence notification value according to the class;
converting the Ethernet packet into the format of a second communication network; and
re-transmitting the converted Ethernet packet to the second communication network.
